(19) United States
(12) Patent Application Publication
(10) Pub. No.: US 2015/0273362 A1
(43) Pub. Date: Oct. 1, 2015

(54) DISTRIBUTOR, SETTLING TANK AND METHOD FOR OPERATING SAME

(71) Applicant: KURITA WATER INDUSTRIES LTD., Nakano-ku, Tokyo (JP)

(72) Inventors: Satoshi Shimizu, Nakano-ku (JP); Mitsuharu Terashima, Kitakyushu-shi (JP)

(21) Appl. No.: 14/441,381

(22) PCT Filed: Nov. 18, 2013
(86) PCT No.: PCT/JP2013/080996

§ 371 Date: May 7, 2015

(30) Foreign Application Priority Data
Nov. 20, 2012 (JP) 2012-254492

(51) Int. Cl. B01D 21/24; B01D 21/00

(52) U.S. Cl. CPC B01D 21/2405; B01D 21/0087

(57) ABSTRACT

Provided are a distributor capable of feeding a liquid in a state of evenly flowing out from an entire opening while avoiding the opening from being blocked by sludge and keeping a pressure loss small, a settling tank that employs the distributor, and a method for operating the settling tank. A distributor 10 being in the form of a rectangular frame and having straight tubular sides 11 to 14 is disposed in a lower space within a settling tank 1. A liquid outlet opening 16 extending in a lengthwise direction of the distributor 10 is formed in a bottom surface of the distributor 10. An open angle θ of the opening 16 with respect to a tube axis is 60 to 180°, and preferably 90 to 150°.

### FIELD OF INVENTION

The present invention relates to a distributor for introducing water to be treated into a settling tank, such as a coagulative settling tank. The present invention further relates to a settling tank that employs the distributor, and a method for operating the settling tank.

### BACKGROUND OF INVENTION

Hitherto, precipitation separation using a solid-liquid separation tank (settling tank) as a means for separating a sludge-mixed liquid into treated water and sludge has been generally employed in active sludge treatment facilities, coagulative settling treatment facilities, and the like. In the precipitation separation, the so-called sludge blanket filtering technique of forming a sludge zone (sludge blanket layer) inside the settling tank is employed to efficiently remove pollutants and minute SS in the sludge-mixed liquid and to obtain satisfactory treated water (Patent Literatures 1 and 2). The sludge-mixed liquid is introduced from a distributor to flow into a region under the sludge zone and to pass through the sludge zone, whereby the pollutants and the minute SS in the sludge-mixed liquid are filtered and separated.

In the settling tanks disclosed in Patent Literatures 1 and 2, tubular distributors are disposed to extend radially from a lower end of a feed well, and raw water (sludge-mixed liquid) flows out from the distributors through openings formed at the distributors.

In Patent Literature 1, each opening is a circular opening, and many openings are formed in a lateral surface of the distributor at intervals. In Patent Literature 2, the opening is formed in a bottom surface of the tubular distributor in a slit-like shape extending in the lengthwise direction of a tube. When the opening is formed in the bottom surface of the distributor as in Patent Literature 2, sludge is prevented from depositing in the distributor.

### LIST OF LITERATURES

Patent Literature 1: Japanese Patent Publication 10-202009 A

Patent Literature 2: Japanese Patent Publication 2000-334214 A

### SUMMARY OF INVENTION

In order to cause a liquid to evenly flow out from the many circular raw-water outlet openings as in Patent Literature 1, a pressure loss needs to be generated in the opening. Accordingly, the power cost for feeding water is increased, and there is a risk that the opening may be blocked by sludge or foreign matters.

In Patent Literature 2, because the width of the slit-like opening is large at the distal end side of the distributor, but it is small at the proximal end side, there is a risk that the opening may be blocked by sludge at the proximal end side of the distributor.

An object of the present invention is to solve the above-mentioned problems in the related art, and is to provide a distributor capable of feeding a liquid in a state of evenly flowing out from an entire opening while avoiding the opening from being blocked by sludge and keeping a pressure loss small, a settling tank that employs the distributor, and a method for operating the settling tank.

### Solution to Problem

The distributor according to the present invention comprises a tubular water feed member, and a liquid outlet opening that is formed in a bottom surface of the water feed member, and that extends in a lengthwise direction of the water feed member. An open angle θ of the opening with respect to a tube axis of the water feed member is 60 to 180°.

The open angle θ is preferably 90 to 150°.

The settling tank according to the present invention comprises a tank body, and the distributor mounted in a lower space within the tank body, wherein the distributor is mounted with the opening directed downwards.

In the settling tank described above, preferably, the distributor has a frame shape or a ring shape when it is looked at in a plan view.

A method for operating a settling tank according to the present invention operates the above-described settling tank. A difference between a specific gravity d₁ of a liquid supplied to the distributor and a specific gravity d₂ of a liquid within the tank body is 0.0001 to 0.1, and d₂>d₁ is satisfied.

### Advantageous Effects of Invention

The distributor and the settling tank of the present invention are used to supply, into the distributor, raw water (liquid to be treated) having a specific gravity smaller than that of a tank liquid within the settling tank (in particular, that of a sludge blanket layer) by 0.0001 to 0.1. Since the raw water introduced to the distributor has a smaller specific gravity than the tank liquid, the raw water flows through the distributor in a lengthwise direction along its ceiling surface, and gradually flows out from the opening into the settling tank along the way. The opening of the distributor has a uniform width in the lengthwise direction of the distributor, and the raw water evenly flows out from the opening into the settling tank with no necessity of generating a large pressure loss when the raw water flows through the distributor. Furthermore, since the opening is formed in the bottom surface of the distributor, sludge is also allowed to flow out from the opening into the settling tank without being deposited in the distributor.

When the central angle θ of the opening is smaller than 60°, there would be risk that the opening is blocked by sludge. When the central angle θ of the opening is larger than 180°, the raw water introduced to the distributor would all flow out from the distributor into the settling tank before reaching a distal end of the distributor. By setting the central angle θ to be 60 to 180° and, in particular, 90 to 150° C., the raw water can be fed in a state of evenly flowing out from the distributor into the settling tank without making the opening blocked by sludge.

A liquid flow in the distributor is disturbed at least on the downstream side near a bent portion in which a water flowing direction in the water feed member is changed at 45° or more. For that reason, preferably, the opening is not formed in the bent portion and the vicinity thereof on the downstream side.

The distributor and the settling tank of the present invention are suitably applied to a sludge-blanket type settling tank, particularly a granulation coagulative settling tank. A flow rate in the distributor is selected depending on the difference in specific gravity between the raw water and the tank liquid, the central angle θ of the opening, and respective lengths of the opening and the distributor.

### BRIEF DESCRIPTION OF DRAWINGS

FIG. 1 is a vertical sectional view of a settling tank according to an embodiment.

FIG. 2 is a sectional view taken along a line II-II in FIG. 1.

FIG. 3 is a sectional view taken along a line in FIG. 2.

FIG. 4 is a bottom view of a distributor.

FIG. 5 is a bottom view of a distributor in a settling tank according to another embodiment.

FIG. 6 is a bottom view of a distributor in a settling tank according to still another embodiment.

FIG. 7 is a bottom view of a distributor in a settling tank according to still another embodiment.

FIG. 8 is a bottom view of a distributor in a settling tank according to still another embodiment.

### DESCRIPTION OF EMBODIMENTS

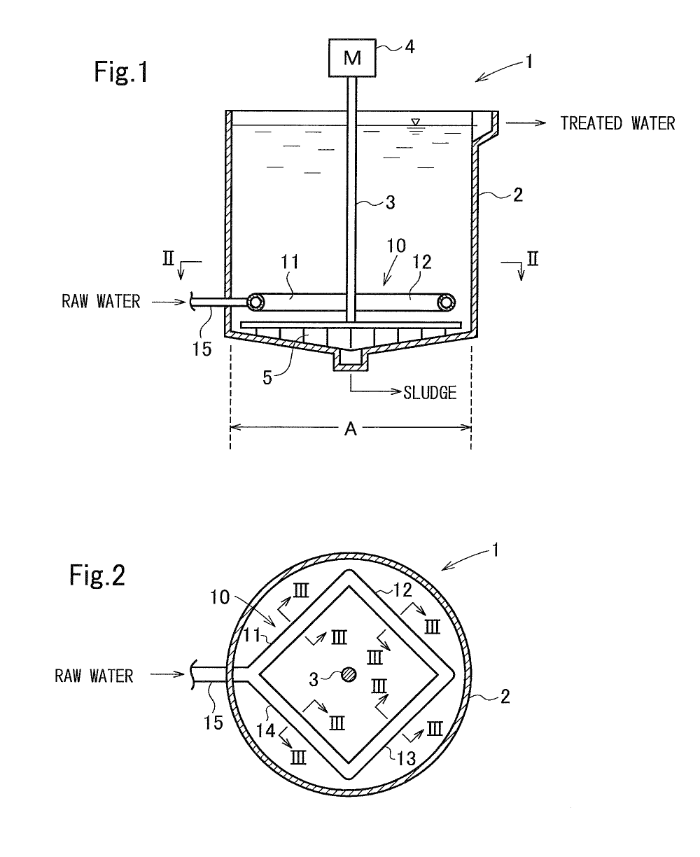

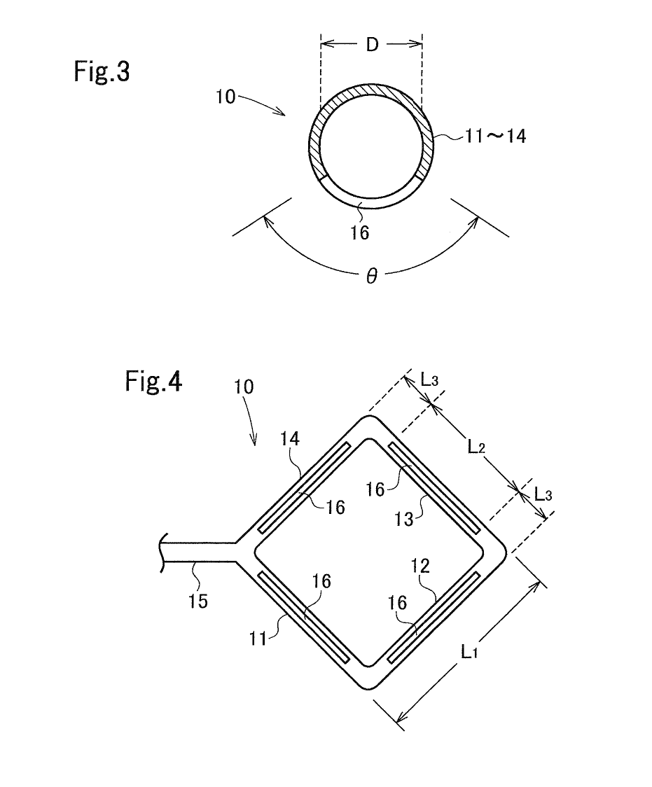

One embodiment of the present invention will be described below with reference to FIGS. 1 to 4.

A settling tank 1 includes a cylindrical tank body 2 with a direction of its axial center line set to the vertical direction, a distributor 10 mounted in a lower space within the tank body 2 (near the bottom of thereof), a shaft 3 arranged at an axial center position of the tank body 2, a driving unit 4 including a motor to rotate the shaft 3, and a rake 5 attached to a lower end of the shaft 3 (see FIG. 1, the rake 5 being not illustrated in FIG. 2).

In this embodiment, the distributor 10 is in the form of a square frame, when it is looked at in a plan view, which has a first side 11, a second side 12, a third side 13, and a fourth side 14. The sides 11 to 14 are each formed of a cylindrical tube having an inner space that serves as a flow path. A raw water introducing tube 15 is connected to a junction between the first side 11 and the fourth side 14. The raw water introducing tube 15 extends in a direction in which a diagonal line of the square distributor 10 extends.

In bottom surfaces of the sides 11 to 14 of the distributor 10, outlet openings 16 are formed to extend in lengthwise directions of the sides 11 to 14. In this embodiment, one opening 16 is formed in each of the sides 11 to 14. The opening 16 extends from a position near one end to a position near the other end of each of the sides 11 to 14. An opening width of the opening 16 is uniform in the lengthwise direction of each side. Therefore, each opening 16 appears as an elongate rectangular shape in FIG. 4 that is a bottom view of the distributor 10. Both the ends of the opening 16 in the lengthwise direction may be rounded.

The sides 11 to 14 of the distributor 10 are each formed of a linear cylindrical tube. An open angle θ of the opening 16 in the bottom surface (i.e., an angle at which the opening 16 is opened in a widthwise direction thereof with respect to an axial center of the tube) is 60° to 180°, and preferably 90° to 150°.

An overall length L₁ of each of the sides 11 to 14 of the distributor 10 is preferably about 50 to 90% and, in particular, 60 to 80% of a diameter A of the tank body 2. A length L₂ of each opening 16 in the lengthwise direction thereof is given by L₁−2L₃. Near corners at which adjacent two of the sides 11 to 14 of the distributor 10 contact each other, the opening 16 is not present over a range of a distance L₃ from an end of each of the sides 11 to 14. L₃ is preferably about 1 to 3 times and, in particular, about 1.2 to 2 times an inner diameter D of the tube.

In the settling tank 1 including the distributor 10 constituted as described above, raw water is introduced to the distributor 10, the raw water having a specific gravity smaller than that of a tank liquid within the settling tank 1 (or that of a sludge blanket when the sludge blanket layer is formed in the settling tank 1) by 0.0001 to 0.1 and, in particular, 0.0005 to 0.05. The introduced raw water flows through the distributor 10 along its ceiling surface, and gradually flows out from the opening 16 into the settling tank 1 along the way. Since the central angle θ of the opening 16 is 60 to 180° and preferably 90 to 150°, sludge is not deposited in the distributor 10, and the opening 16 is prevented from being blocked by the sludge.

In this embodiment, the distributor 10 is bent at 90° near the corners of the distributor 10 at which the sides 11 and 12, the sides 12 and 13, and the sides 13 and 14 intersect each other. Therefore, the flow in the distributor 10 is disturbed near each of the corners, particularly at the corner and in a region near the corner on the downstream side. The sides 11 and 14 are branched at an angle of 45° relative to the raw water introducing tube 15. Hence the flow in the distributor 10 is also disturbed near a branched portion, particularly on the downstream side. In this embodiment, since the opening 16 is not formed over the range of the distance L₃ from each of the corners on both the upstream side and the downstream side, the raw water is avoided from flowing out in a large amount from the distributor 10 into the settling tank 1 near the corners. Since the flow is disturbed near the corners (bent portions), sludge is prevented from being deposited near the corners (bent portions). The bent portion means, for example, a portion where a flow path is bent at 45° or more on its way over a length that is about not more than 5 times an inner diameter D of the tube, or a portion where the flow path is branched steeply at an angle in such a range. When the bent portion is formed as the branched portion, the downstream side of the bent portion means the downstream side of the branched portion.

### OTHER EMBODIMENTS

While, in the above-described embodiment, the opening 16 is provided in continuous form in the lengthwise direction of each of the sides 11 to 14, the opening 16 may be provided plural in intermittent form for each side. In that case, the width of each of the plural openings is also uniform in the lengthwise direction thereof. The openings are preferably provided at equal intervals in each side.

In the following embodiments as well, the opening may be provided plural in intermittent form.

While, in the above-described embodiment, the raw water introducing tube 15 is connected to the portion at which the sides 11 and 14 of the distributor 10 intersect each other, the raw water introducing tube 15 may be connected to an intermediate portion of one side 11 as in a distributor 10A of FIG. 5. In that case, because a portion near a junction point between the raw water introducing tube 15 and the side 11 is regarded as the bent portion, the opening 16 is not provided in such a portion.

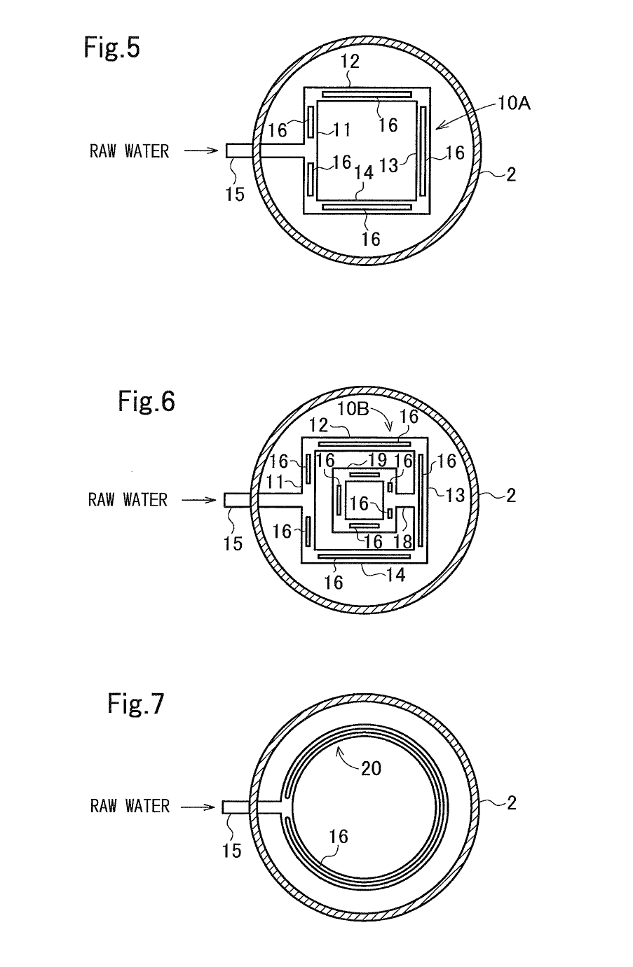

In the present invention, as in a distributor 10B of FIG. 6, a square ring-shaped tube 19 connected to the side 13 through a tube 18 may be added to the distributor 10A of FIG. 5 to provide a double ring shape when looked at in a plan view. Openings 16 are also formed in a lower surface of the square ring-shaped tube 19. However, the openings 16 are not formed near bent portions at four corners of the square ring-shaped tube 19 and near a portion of the square ring-shaped tube 19 to which the tube 18 is connected.

A distributor 20 of FIG. 7 has a circular ring shape when looked at in a plan view. An opening 16 is formed over an entire bottom surface of the distributor 20 except for the vicinity of a portion where the raw water introducing tube 15 and the distributor 20 are connected to each other.

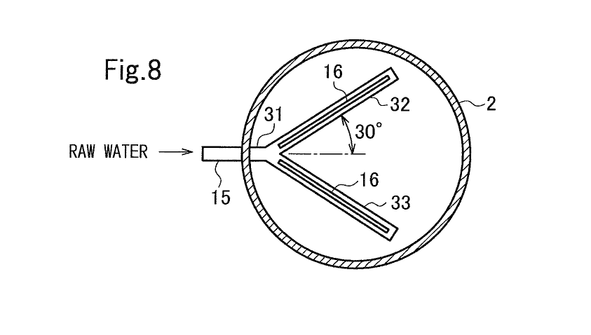

A distributor 30 of FIG. 8 includes three straight tubes 31, 32 and 33 radially extending in three directions. Of those tubes 31, 32 and 33, one 31 is shorter than the other tubes 32 and 33. The raw water introducing tube 15 is connected to an end of the tube 31. In this embodiment, an angle of the tube 31 with respect to a water flowing direction in a portion branched from the tube 31 to the tubes 32 and 33 is 30° that is smaller than 45°. Thus, a portion where the tubes 31, 32 and 33 intersect one another is not regarded as the bent portion. Therefore, an opening 16 is formed in an entire bottom surface of each of the tubes 32 and 33.

It is to be noted that, in the distributor 30 of FIG. 8, distal ends of the straight tubes 32 and 33 are closed.

Among the distributors described above, those ones illustrated in FIGS. 2, 5 and 8 are relatively easy to manufacture and hence are preferable. The distributors 10 and 10A of FIGS. 2 and 5 are preferable in such a point that the raw water is more apt to evenly flow out from the openings 16.

### EXAMPLES

### Experiment 1

### Raw Water Outflow Experiment at Different Open Angles θ of Distributor

The distributor illustrated in FIG. 5 was mounted in a settling tank with a diameter of 150 cm and a water depth of 150 cm, which was installed outdoor and which was not provided with a stirrer, at a height of 10 cm from the bottom of the settling tank. A tube constituting the distributor had an outer diameter of 114 mm and an inner diameter of 107 mm. A length of each of the sides 11 to 14 was 110 cm, a length of the opening 16 in each of the sides 12 to 14 was 70 cm, and a length of each opening 16 in the side 11 was 20 cm. The open angle θ of the opening 16 was set as listed in Table 1. The tube was made of vinyl chloride. An inner space of the settling tank under the distributor was partitioned by a baffle plate into a region at the proximal end side (i.e., the side closer to the raw water introducing tube 15) and a region at the distal end side, thus enabling an operator to confirm that the raw water was evenly supplied to the front side of the baffle plate and the rear side thereof.

Raw water was prepared by adding 300 mg/L of aluminum sulfate and 1 mg/L of a cation polymer (Kurifarm PC728 made by Kurita Water Industries Ltd.) to kaolin-dispersed water, which was prepared by adding 500 mg/L of kaolin to tap water, thereby forming flock, and then adding 3 mg/L of an anion polymer (Kurifarm PA465 made by Kurita Water Industries Ltd.). The prepared raw water was supplied to the distributor at a flow rate of 30 m³/h. The specific gravity of a liquid inside tank was set to be larger than that of the supplied raw water by about 0.0052.

The occurrence of blockage of the openings 16 and conditions of outflow from the openings 16 were observed while the raw water was supplied continuously for 48 h. Furthermore, measurement was performed on an outflow rate of the raw water from the openings 16 at the proximal end side of the distributor (i.e., at the side closer to the raw water introducing tube 15, namely at the left-half side with respect to a center of the tank body 2 in FIG. 5) and an outflow rate of the raw water from the openings 16 at the distal end side of the distributor (i.e., at the right-half side in FIG. 5). The obtained results are listed in Table 1.

TABLE 1

| | | | | Outflow Rate of | |
|---|---|---|---|---|---|
| | | Occurrence of | Outflow Conditions of | Raw Water (m³/hr) | |
| | Open | Blockage of | Raw Water from | Proximal | Distal |
| | Angle θ | Openings | Openings | End Side | End Side |
| COMPARATIVE | 45° | Blocked after | Even outflow into | 15 | 15 |
| EXAMPLE 1 | | 24 h | entire tank | | |
| EXAMPLE 1 | 60° | Not blocked | Even outflow into | 15 | 15 |
| | | | entire tank | | |
| EXAMPLE 2 | 90° | Not blocked | Even outflow into | 15 | 15 |
| | | | entire tank | | |
| EXAMPLE 3 | 120° | Not blocked | Even outflow into | 15 | 15 |
| | | | entire tank | | |
| EXAMPLE 4 | 150° | Not blocked | Even outflow into | 16.1 | 13.9 |
| | | | entire tank | | |
| EXAMPLE 5 | 180° | Not blocked | Almost even outflow into | 18 | 12 |
| | | | entire tank | | |
| COMPARATIVE | 210° | Not blocked | Outflow rate is larger at | 22.5 | 7.5 |
| EXAMPLE 2 | | | proximal end side | | |

As seen from Table 1, in EXAMPLES 1 to 5 in which the open angle θ is 60 to 180°, the raw water evenly flows out from the distributor between the distal end side and the proximal end side, and the openings are not blocked. On the other hand, in COMPARATIVE EXAMPLE 1 in which the open angle θ is 45°, the openings are clogged with and blocked by sludge attributable to kaolin, leaves of trees, and dead branches in a short time. In COMPARATIVE EXAMPLE 2 in which the open angle θ is 210°, the raw water does not evenly flow out from the distributor.

### Experiment 2

### Raw Water Outflow Experiment Using Distributor of FIG. 8

An experiment was performed under the same conditions as those in EXAMPLE 3 except for using the distributor illustrated in FIG. 8 (the open angle θ being 120° and equal to that in EXAMPLE 3). The experiment result showed that the outflow rate from the proximal end side of the distributor was 4.5 m³/hr while the outflow rate from the distal end side thereof was 25.5 m³/hr, and that the raw water flowed out at a much larger flow rate from the distal end side.

### Experiment 3

### Experiment on Outflow from Distributor with Openings 16 Formed all Continuously

In EXAMPLE 3, the openings 16 in the four sides of the distributor were all formed continuously. The raw water was supplied under the same conditions as those in EXAMPLE 3 except for using that distributor. The experiment result showed that the outflow rate from the proximal end side was 25 m³/hr while the outflow rate from the distal end side was 5 m³/hr, and that the raw water flowed out at a much larger flow rate from the proximal end side.

From the experiments described above, it was confirmed that the distributor according to the present invention can feed a liquid in a state of evenly flowing out from the entirety of one or more openings without causing blockage of the openings.

While the present invention has been described in detail in connection with specific embodiments, it is apparent to those skilled in the art that the present invention can be variously modified without departing from the intent and the scope of the present invention.

This application is on the basis of Japanese Patent Application No. 2012-254492 filed Nov. 20, 2012, which is incorporated by reference herein in its entirety.

1. A distributor comprising a tubular water feed member, and a liquid outlet opening that is formed in a bottom surface of the water feed member, and that extends in a lengthwise direction of the water feed member,
wherein an open angle θ of the opening with respect to a tube axis of the water feed member is 60 to 180°.

2. The distributor according to claim 1, wherein the open angle θ is 90 to 150°.

3. The distributor according to claim 1, wherein the opening is not present at least on the downstream side near a bent portion in which a water flowing direction in the water feed member is changed at 45° or more.

4. A settling tank comprising a tank body, and the distributor according to claim 1, the distributor being mounted in a lower space within the tank body,
wherein the distributor is mounted with the opening directed downwards.

5. The settling tank according to claim 4, wherein the distributor has a frame shape or a ring shape when the distributor is looked at in a plan view.

6. A method for operating the settling tank according to claim 4, wherein a difference between a specific gravity d₁ of a liquid supplied to the distributor and a specific gravity d₂ of a liquid within the tank body is 0.0001 to 0.1, and d₂>d₁ is satisfied.
